(19) United States
(12) Patent Application Publication
(10) Pub. No.: US 2010/0281064 A1
(43) Pub. Date: Nov. 4, 2010

(54) HIERARCHY STRUCTURE DISPLAY DEVICE, HIERARCHY STRUCTURE DISPLAY METHOD AND HIERARCHY STRUCTURE DISPLAY CONTROL PROGRAM

(76) Inventor: Teruya Ikegami, Tokyo (JP)

Correspondence Address: Mr. Jackson Chen, 6535 N. STATE HWY 161, IRVING, TX, 75039, US

(21) Appl. No.: 12/746,588

(22) PCT Filed: Nov. 28, 2008
(86) PCT No.: PCT/JP2008/071612

§ 371 Date: Jun. 7, 2010

(30) Foreign Application Priority Data
Dec. 6, 2007 (JP) 2007 315761

(51) Int. Cl. G06F 17/30

(52) U.S. Cl. 707/797; 707/E17.012

(57) ABSTRACT

This object aims to provide a technology for solving a problem so that the following link relations can be made clear even when a part of a region of a hierarchy structure is limited to display and nodes are arranged in the form in which unknown upper and lower relations of the hierarchy are entered in the displayed region. A tree display unit (203) reads out a tree structure of data from a hierarchy structure information recording unit (201) and displays a part of the tree structure in a tree display region of an output unit (202). A display parent determination unit (206) determines a parent node for a child node with an unknown parent and child relation from the display and displays a text of the parent node in a tree bar adjacent to the tree display region. Further, it is also possible to shift contents of the display contents shift to the tree display region and display the same, so as to render the parent and child relation recognizable.

### TECHNICAL FIELD

The present invention relates to a technology for visually displaying a hierarchy of data, and particularly, to a technology for displaying data in a large hierarchy within a relatively small region.

### BACKGROUND ART

Systemization of data to be processed in a tree structure by putting every file in a corresponding folder and associating several folders with one directory enables efficient retrieval of desired data. When the structure of the data in such a hierarchical structure is desired to be visually presented on a display device of an information processing apparatus, especially when the hierarchy has a large size, an area for display becomes large. This is because an increased number of levels in the tree depth direction may result in an increase of the length over which nodes are displayed in the depth direction, and/or because some levels having a large number of nodes may appear, and this results in an increased length over which these nodes are displayed in a direction orthogonal to the depth direction. Thus, when a large hierarchy of data is desired to be displayed in a limited region, some required nodes may be omitted from the display in the region, so that the position of a desired node sometimes cannot be found.

Several kinds of studies have been made to solve such a problem in display. For example, a tool called Explorer, which is for managing files and folders, supported by Windows (a registered trademark), which is an OS (Operating System) from Microsoft Corporation, and mail software called Outlook Express also from Microsoft Corporation employ a first prior-art technique related to the present invention.

The first prior-art technique displays information about a selected node in a tree region, in a region separate from the tree region. As used herein, the term information about a selected node refers to information on files and/or child nodes contained in the present node, an address of the present node, and the like. By displaying such information about a node in a separate region, simplification of display of a region in which the tree structure is displayed may be achieved, and as many nodes as possible can be displayed in the region.

Even by the first prior-art technique, however, it is still difficult to display all nodes in one display area for a relatively large hierarchy. Accordingly, in a case that all nodes in a tree cannot be displayed in a tree region, the first prior-art technique provides a vertical or horizontal scroll bar in the region. The vertical or horizontal scroll bar may be operated as needed to display a required portion in the tree that is not displayed in the display area.

The first prior-art technique thus requires a window scroll operation for a relatively large hierarchy, resulting in a problem that such an operation is cumbersome, and in addition, a parent node of a currently displayed node is difficult to find. Moreover, it poses another problem that when one of nodes displayed in a display area is selected, eyes must be moved to catch node information displayed in a separate region.

Accordingly, there has been proposed a second prior-art technique related to the present invention comprising dynamically rearranging upper-level elements and displaying more information within a display window (Patent Document 1).

FIGS. 17 and 18 are for explaining the second prior-art technique. Referring to FIG. 17, first and second middle nodes 102₁, 102₂ are present at a level immediately below an upper node 101. Moreover, first-third lower nodes 103₁-103₃ are present at a level immediately below the first middle node 102₁, and fourth and fifth lower nodes 103₄-103₅ are present at a level immediately below the second middle node 102₂. Now assume that a display window 104 surrounded by a dot-dash line represents a bounded region in which a hierarchy is displayed.

In this example, the fourth and fifth lower nodes 103₄, 103₅ are displayed in the display window 104 with its parent node, the second middle node 102₂, allowing their relationship to be recognized. On the other hand, for the third lower node 103₃, its parent node, the first middle node 102₁, falls outside the display window 104, so that their positional relationship cannot be known.

FIG. 18 shows the second prior-art technique solving the problem. Specifically, in the second prior-art technique, decision is made as to whether the upper first middle node 102₁, which connects to the node of interest, the third lower node 103₃, can be accommodated within the display window 104 by moving it in the vertical direction. In a case that it can be accommodated, rearrangement is applied by changing the display position of the first middle node 102₁ into the display area of the display window 104. The second prior-art technique thus uses a display margin, if present, in the display window 104 to lay out more nodes.

However, unlike such a tree display as supported by Explorer or the mailer in the first prior-art technique, additional nodes are packed together in a display margin according to the second prior-art technique, and as a result, the depth of a level cannot be correlated with a display position. Consequently, a parent node may be sometimes laid at a lower position than a child node, resulting in a problem that it becomes difficult to know which parent node the currently displayed child node belongs to. There is also another problem that it cannot be known whether any child node at the same level as the child nodes currently displayed in the display window 104 is present in an upper position of the level. Moreover, the second prior-art technique involves drawing link lines for linking individual nodes with one another in order to present the rank of nodes. This poses still another problem that drawing of the link lines hampers efficient display of nodes.

Accordingly, display of a hierarchy using three-dimensional graphics has been proposed as a third prior-art technique related to the present invention (Patent Document 2). The technique comprises placing a first-level node at an apex of a cone, and sequentially placing second-level and subsequent nodes downward along the surface of the cone at certain intervals. Thus, nodes are placed over the whole surface of the cone, like decorations on a Christmas tree. The three-dimensional graphic is rendered in a plane as if its photograph were taken.

Patent Document 1: JP-P2001-331358A (Paragraph 0014, FIG. 7)

Patent Document 2: JP-P2000-047778A (Paragraph 0005, FIG. 1)

### DISCLOSURE OF THE INVENTION

### Problems to be Solved by the Invention

According to the third prior-art technique, however, since three-dimensionally rendered graphic information is projected onto a two-dimensional plane, some nodes and link lines connecting nodes overlap one another, and moreover, part of the information may be hidden. This may cause the tree structure itself to be wrongly interpreted. Thus, as compared with the two-dimensionally developed tree, there is a problem that an operation becomes complicated in processing data, such as an operation of moving a folder, because the tree structure cannot be intuitively understood.

It is therefore an object of the present invention to provide a hierarchical structure display apparatus, a hierarchical structure display method, and a hierarchical structure display control program capable of clearly displaying a linking relationship of nodes when a partial region of a hierarchy should be limitedly displayed, even in a case that nodes, whose ranks in the hierarchy are unknown, are complicatedly placed in a display area.

### Means for Solving the Problems

The present invention provides a hierarchical structure display apparatus comprising: a hierarchical data storage for holding hierarchical data which is data in a hierarchical structure; a tree region generating means for receiving said hierarchical data from said hierarchical data storage as an input, and generating a tree region in which nodes are displayed in a tree form within a predetermined viewport in a predetermined direction from one end of said viewport in a sequence of a hierarchical relationship from a node at an upper level toward its subordinate node at a lower level; a presence-of-parent-node deciding means for deciding whether a node contained in the tree region generated by said tree region generating means has a node at an immediately upper level corresponding to a parent falling outside the tree region, from a relationship between the hierarchical data supplied to said tree region generating means from said data storage for display and its vicinal hierarchical data; and a parent-node-identifying-information display means for, when it is decided by said presence-of-parent-node deciding means that said node at the level corresponding to a parent falling outside said tree region exists, displaying parent node identifying information representing said node at a predetermined position.

The present invention also provides a hierarchical structure display method comprising: a tree region generating step of receiving, from a hierarchical data storage for holding hierarchical data which is data in a hierarchical structure, said hierarchical data as an input, and generating a tree region in which nodes are displayed in a tree form within a predetermined viewport in a predetermined direction from one end of said viewport in a sequence of a hierarchical relationship from a node at an upper level toward its subordinate node at a lower level; a presence-of-parent-node deciding step of deciding whether a node contained in the tree region generated at said tree region generating step has a node at an immediately upper level corresponding to a parent falling outside the tree region, from a relationship between the hierarchical data supplied to said tree region generating means from said data storage for display and its vicinal hierarchical data; and a parent-node-identifying-information display step of, when it is decided at said presence-of-parent-node deciding step that said node at the level corresponding to a parent falling outside said tree region exists, displaying parent node identifying information representing said node in the proximity of said viewport for displaying the tree region generated by said tree region generating means.

Moreover, the present invention provides a hierarchical structure display control program causing a computer that comprises a hierarchical data storage for holding hierarchical data which is data in a hierarchical structure, to execute: tree region generating processing of receiving said hierarchical data from said hierarchical data storage as an input, and generating a tree region in which nodes are displayed in a tree form within a predetermined viewport in a predetermined direction from one end of said viewport in a sequence of a hierarchical relationship from a node at an upper level toward its subordinate node at a lower level; presence-of-parent-node deciding processing of deciding whether a node contained in the tree region generated by said tree region generating processing has a node at an immediately upper level corresponding to a parent falling outside the tree region, from a relationship between the hierarchical data supplied for said tree region generating processing from said data storage and its vicinal hierarchical data; and parent-node-identifying-information display processing of, when it is decided by said presence-of-parent-node deciding processing that said node at the level corresponding to a parent falling outside said tree region exists, displaying parent node identifying information representing said node in the proximity of said viewport for displaying the tree region generated by said tree region generating means.

### EFFECTS OF THE INVENTION

Thus, according to the present invention, when a partial region of a hierarchy is limitedly displayed in a tree region in a predetermined viewport, parent node identifying information about a parent node that is not displayed in relation to child nodes displayed in the region is displayed at a predetermined position, so that a linking relationship, which cannot be known merely from the tree region, can be immediately discriminated without changing a displayed range in the tree region. Therefore, an operation can be more quickly and positively achieved as compared with a case in which, for example, a scroll bar is operated to make such identification.

### BRIEF DESCRIPTION OF THE DRAWINGS

FIG. 1 A block diagram showing a configuration of a hierarchical structure display apparatus in a first embodiment of the present invention.

FIG. 2 A plan view showing an example of display at an output section in the first embodiment.

FIG. 3 A flow chart representing processing of displaying a parent node in a tree bar in the first embodiment.

FIG. 4 A plan view showing the main portion of a viewport in a first example of the present invention.

FIG. 5 A plan view showing the main portion of the viewport shown in FIG. 4 after scrolling display of the tree slightly downward.

FIG. 6 A plan view showing the main portion of the viewport in a case that display in the depth direction cannot be accommodated within the tree display area in the first example.

FIG. 7 A plan view showing the main portion of the viewport in another case that display in the depth direction cannot be accommodated within the tree display area in the first example.

FIG. 8 A block diagram showing a configuration of a hierarchical structure display apparatus in a second embodiment of the present invention.

FIG. 9 A plan view showing an example of display at an output section in the second embodiment.

FIG. 10 A flow chart representing an example of shift control for tree display in a tree display section in the second embodiment of the present invention.

FIG. 11 A plan view of a viewport showing a condition in which the tip of the cursor is moved to point at a tree bar at Step S602 in FIG. 10.

FIG. 12 A plan view of the viewport showing a condition after clicking on the tree bar in the condition shown in FIG. 11 by a mouse.

FIG. 13 A plan view showing an example of a viewport according to a third example of the present invention.

FIG. 14 A plan view showing an example of a viewport according to a fourth example of the present invention.

FIG. 15 A plan view showing an example of a viewport according to a fifth example of the present invention.

FIG. 16 A flow chart representing movement condition selection control in a tree display section in the fifth example.

FIG. 17 An explanatory diagram showing a tree structure and its display condition before applying the second prior-art technique related to the present invention.

FIG. 18 An explanatory diagram showing the tree structure and its display condition after applying the second prior-art technique related to the present invention.

### EXPLANATION OF SYMBOLS

200, 200A Hierarchical structure display apparatus
201 Hierarchy information recording section
202 Output section
203, 203A Tree display section
206 Parent-node-to-be-displayed determining section
207, 207A Tree bar display section
214 CPU
215, 215A Memory
216, 216A Control section
221 Display screen
222 Tree display area
223, 223A, 223B Tree bar
226 Parent node displaying parent/child nodes lying region
231, 232, 233 Node
501 Tree bar operation control section
502 Input section
521 Cursor
561 Pop-up menu

### BEST MODES FOR CARRYING OUT THE INVENTION

### First Embodiment

Now a first embodiment of the present invention will be described.

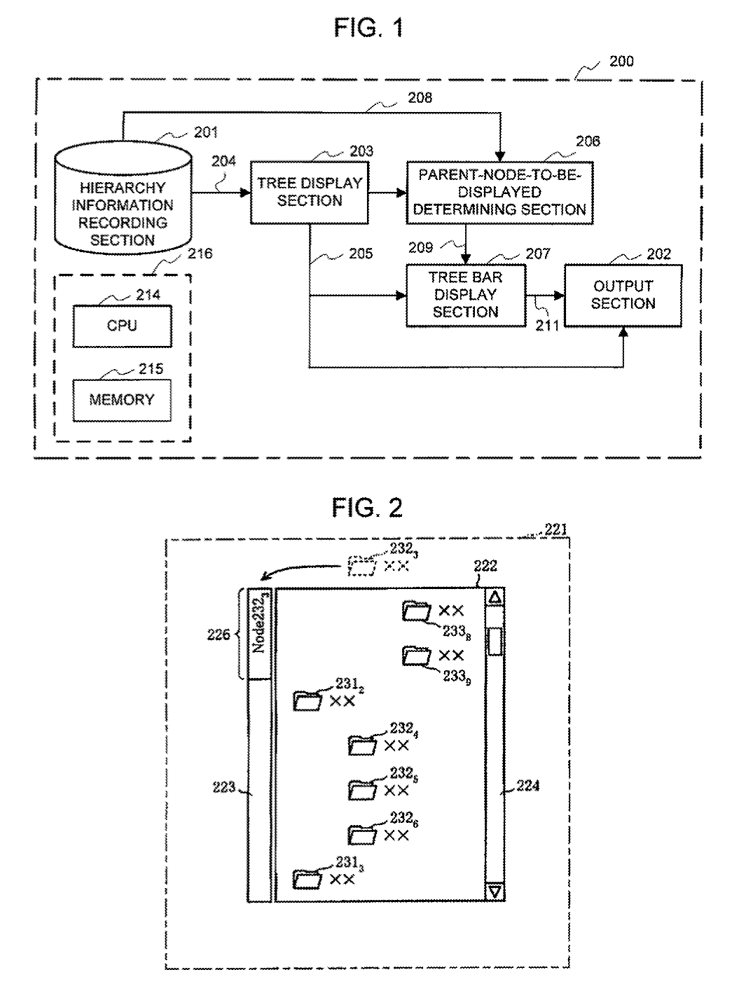

FIG. 1 represents a configuration of a hierarchical structure display apparatus in the first embodiment. The hierarchical structure display apparatus 200 is comprised of an ordinary information processing apparatus in which, for example, a personal computer is combined with a display device serving as an output section.

The hierarchical structure display apparatus 200 comprises a hierarchy information recording section 201, such as a hard disk, in which several kinds of data in a hierarchical structure are recorded. The hierarchy information recording section 201 is connected with a tree display section 203 for generating tree display in a predetermined tree display area at an output section 202. The tree display section 203 is for loading hierarchical data 204 required in display from the hierarchy information recording section 201, generating tree display information 205, supplying it to the output section 202, and displaying it within a tree display area (not shown). Display at the output section 202 according to the tree display information 205 is made as in display by Explorer, for example, supported by Windows (a registered trademark), which is an OS from Microsoft Corporation.

The hierarchical structure display apparatus 200 in the present embodiment is provided with a parent-node-to-be-displayed determining section 206 and a tree bar display section 207, in addition to the tree display section 203. Of these, the parent-node-to-be-displayed determining section 206 loads hierarchical data 208 for the whole tree structure displayed by the tree display section 203 from the hierarchy information recording section 201. Then, in a case that there exists any child node whose rank in the hierarchy cannot be known among those in the tree structure displayed within the tree display area at the tree display section 203, its parent node is determined. The name of the determined parent node is sent to the tree bar display section 207 as parent node information 209.

The tree bar display section 207 is a display section placed adjacent to the aforementioned tree display area. The tree bar display section 207 receives the tree display information 205 generated by the tree display section 203 as input, displays a tree bar adjacent to the tree display area, clearly indicates in the bar a position corresponding to the aforementioned child node whose rank in the hierarchy cannot be known, and incorporates text information representing a parent node at that position based on the parent node information 209. The thus-created tree bar display information 211 is then sent to the output section 202 from the tree bar display section 207.

The thus-configured hierarchical structure display apparatus 200 has a control section 216 comprising a CPU (Central Processing Unit) 214, and a memory 215 for storing therein several kinds of control programs executed by the CPU 214. When a hierarchical structure display control program in the present embodiment is executed as a control program, at least part of the functions of the tree display section 203, parent-node-to-be-displayed determining section 206 and tree bar display section 207 can be implemented by software.

FIG. 2 shows an example of display at the output section. A display screen 221 in the output section displays a commonly used tree display area 222, in which a tree structure based on the tree bar display information 211 shown in FIG. 1 is displayed. The tree display area 222 is provided with a tree bar 223 placed at its adjacency.

In the tree display area 222, nodes 231₂, 231₃ at a certain level are placed near the left edge in the drawing. Out of these, the node 231₂ placed on an upper side can be seen to be linked with three nodes 232₄-232₆ at an immediately lower level. While two nodes 233₈, 233₉ lying in the upper right portion of the tree display area 222 are child nodes of a node 232₃ that is their parent node, the node 232₃ is not displayed because it lies outside the display range of the tree display area 222. Thus, a user cannot identify the parent-child relationship of the two nodes 233₈, 233₉ in the display condition of the tree display area 222.

According to the present embodiment, the parent-node-to-be-displayed determining section 206 shown in FIG. 1 determines that the parent node of the two nodes 233₈, 233₉ is the node 232₃, and displays its parent node information 209 (FIG. 1) as text information in the tree bar 223. Therefore, the user can know a parent node (node 232₃) of child nodes (node 233₈, 233₉) that would otherwise be unknown, without moving display in the tree display area 222 by, for example, a slider bar 224.

It should be noted that the symbol xx on the right side of icons of the nodes 231, 232, 233 in FIG. 2 represents a node name (text information) of each node. In FIG. 2, these node names are legibly displayed in the tree display area 222. However, in a case that an offset occurs in the display position in the depth direction, some nodes may have their node names partially dropped out and incompletely displayed. In such a case, again, a parent node sometimes cannot be known, and therefore, the parent node is displayed in the tree bar 223.

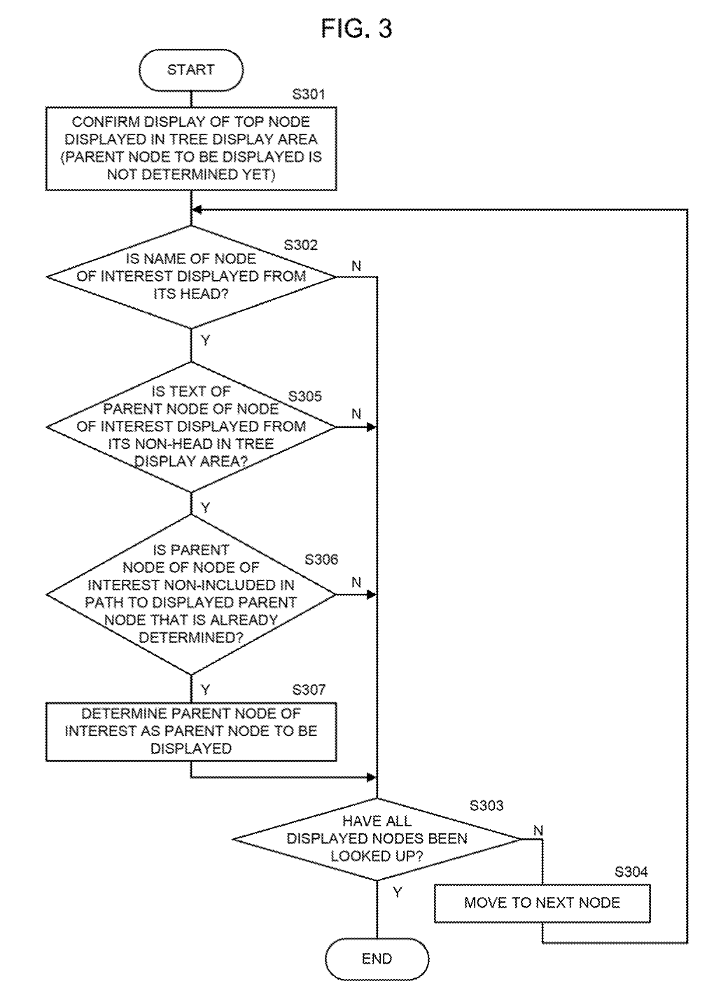

FIG. 3 is a chart representing processing of displaying a parent node in a tree bar in the present embodiment. The following description will be made with reference to FIGS. 1 and 2. The control section 216 first starts confirmation processing starting from a top node displayed in the tree display area 222 (Step S301). At that time, a parent node to be displayed in the tree bar 223 is not determined yet.

For the node for which the confirmation processing is started, the control section 216 checks whether its node name is displayed from its head (Step S302). In a case that the node name is dropped out and incompletely displayed as discussed earlier (N), a decision is made as to whether the confirmation processing has been completed for all nodes displayed in the tree display area 222 (Step S303). In the present case, the processing has just been started for the first node, the confirmation processing is not completed for all nodes (N). Therefore, the processing goes to a next node displayed in the tree display area 222 (Step S304). The processing then goes back to Step S302 again.

On the other hand, in a case that the node name is decided to be displayed from its head at Step S302 (Y), the control section 216 checks whether the node name (text) of a parent node of the node of interest to be confirmed is displayed from its non-head in the tree display area 222 (Step S305). In a case that the node name of the parent node of the node of interest is displayed from its head in the tree display area 222 (N), there is no need to search for a parent node to be displayed in the tree bar 223. In this case, the process goes to Step S303, and the processing similar to that described earlier is repeated.

On the other hand, in a case that the node name of the parent node of the node of interest to be confirmed is displayed from its non-head in the tree display area 222 (Step S305: Y), the control section 216 checks whether the parent node of the node of interest to be confirmed is included in a path from a root to the displayed parent node that is already determined (Step S306). In a case that it is not included in the path to the existing displayed parent node, the process goes to next Step S307. In a case that it is included in the path to the existing displayed parent node (Step S306: N), there is no need to search for a parent node of the currently checked node that is to be displayed in the tree bar 223. Accordingly, in this case, the process goes to Step S303, and the processing similar to that described earlier is repeated.

On the other hand, in a case that it is not included in the path to the existing displayed parent node (Step S306: Y) and the next step is reached, the parent node of the node of interest to be confirmed is determined as a parent node to be displayed at Step S307. In this case, again, the process goes to Step 303 to make a check as to whether the confirmation has been completed for all nodes displayed in the tree display area 222. In this way, when the confirmation is completed for all nodes displayed in the tree display area 222 (Step S303: Y), the processing of displaying a parent node in the tree bar 223 is terminated.

Although omitted from the illustration of the processing described above, processing of determining where in the tree bar 223 the node name (text) of the determined parent node should be displayed may be sometimes required. For example, in FIG. 2, a parent node displaying parent/child nodes lying region 226 (a region along which child nodes of a parent lie and in which the parent node should be displayed) is displayed in a sub-section in the tree bar 223, and within the region is displayed the node name of the parent node, which is the text “Node 212₃.”

In executing such processing, nodes displayed in the tree display area 222 are sequentially scanned from the top one, and before going to check of a next node at Step S304, a history representing whether the parent node of the currently checked node is displayed in the tree display area 222 may be left in the memory 215. Then, the node name of the parent node determined at Step S307 may be displayed in a region (parent node displaying parent/child nodes lying region 226) occupied by a portion in which no parent node is displayed in the tree display area 222. It should be noted that the parent node displaying parent/child nodes lying region 226 may be colored such that it is discriminated from other regions in the tree bar 223.

### Example 1

Next, as a first example of the present invention, a specific example of display of the tree display area 222 generated by the tree bar display section 207 in FIG. 1 and output by the output section 202 and its vicinity will be shown in some viewports. Reference symbols used in FIGS. 1 and 2 are also used in the first example as appropriate.

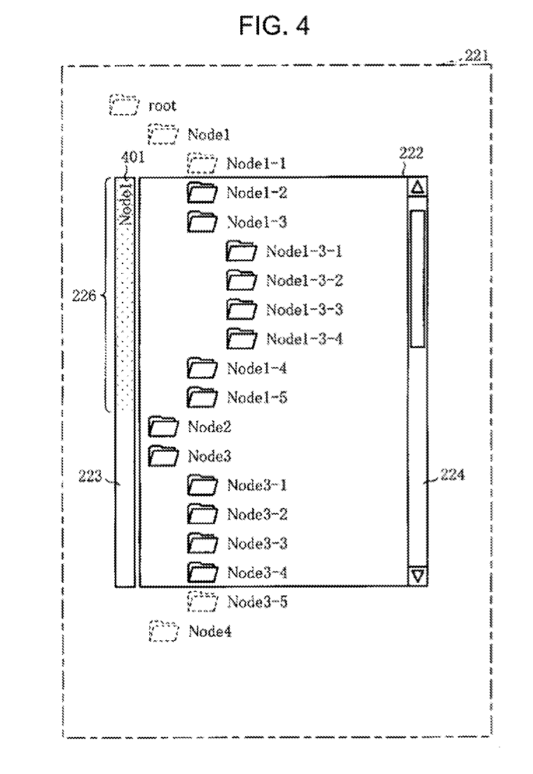

FIG. 4 shows an example of a viewport in the output section. The display screen 221 has a portion in which a tree display area 222 is displayed, and on a right edge thereof is placed a slider bar 224. In the tree display area 222, nodes in part of a tree structure are displayed in position such that a node nearer to the left side is at a higher level in a hierarchy. On the left side of the tree display area 222, a tree bar 223 is placed adjacent to the region.

In the first example, a background color of the display screen 221 is white (transparent), and lines delimiting the tree display area 222 and icons of folders representing the nodes displayed in the tree display area 222 are colored in black. Moreover, the parent node displaying parent/child nodes lying region 226 in the tree bar 223 is colored in light blue, where text information 401 about a parent node is put in black.

In FIG. 4, the vicinity of the tree structure is indicated by a dashed line around the tree display area 222 as a reference. Thus, it can be seen that a parent node of a child node “Node 1-2” displayed at the upper end of the tree display area 222 is “Node 1.” The parent node “Node 1” is consistent with the text information 401 about the parent node. The parent node “Node 1” has child nodes “Node 1-4” and “Node 1-5,” in addition to “Node 1-2,” “Node 1-3.” Therefore, the parent node displaying parent/child nodes lying region 226 is aligned with a region over which these child nodes are displayed, so that the user can readily know a range of child nodes whose parent node is “Node 1.”

For other nodes also displayed in the tree display area 222, that is, for “Node 2” and “Node 3,” their parent node is “root.” However, “root” is included in a path to “Node 1 (displayed parent node)” currently determined as a parent node (\\root\Node 1). Therefore, the node “root” is omitted from the tree bar 223 to be displayed as a parent node.

Moreover, for “Node 3-1” through “Node 3-4,” their parent node “Node 3” is displayed within the tree display area 222. Thus, for “Node 3-1” through “Node 3-4,” their parent node “Node 3” is omitted from display in the tree bar 223. Although the parent node displaying parent/child nodes lying region 226 is colored in light blue in the first example in expressing a range of the displayed parent node in the tree bar 223, the present invention is not limited thereto. For example, a line surrounding a display area for child nodes may be made bold, or to highlight a background of the parent node displaying parent/child nodes lying region 226, the portion may be given a background pattern such as dot shading.

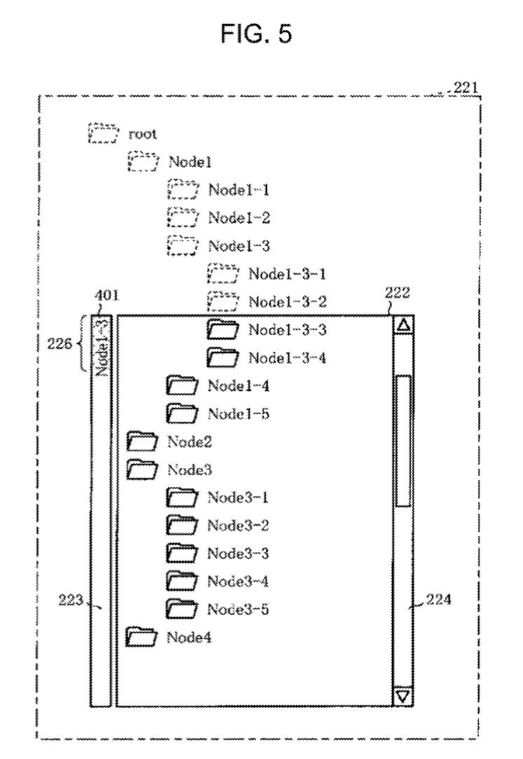

FIG. 5 is a diagram showing the display of the tree structure in the viewport shown in FIG. 4 after slightly scrolling the display to a lower position of the tree. It is assumed that the user operates the slider bar 224 to modify a range in which the tree is displayed such that “Node 1-3-3” and “Node 1-3-4” are placed in the upper portion of the tree display area 222. In this case, a parent node of “Node 1-3-3” and “Node 1-3-4” is “Node 1-3,” which now falls outside the display range of the tree display area 222.

The processing of displaying a parent node in the parent tree bar described with reference to FIG. 3 is activated each time the user scrolls the tree displayed in the tree display area 222. In the example shown in FIG. 5, as a result of such a calculation, the text “Node 1-3” representing the parent node is displayed in the parent node displaying parent/child nodes lying region 226. However, in this example, since the width of the parent node displaying parent/child nodes lying region 226 is smaller than the text to be displayed, the text is displayed with one end lying at the upper end of the tree display area 222, while the other end of the text extends beyond the parent node displaying parent/child nodes lying region 226. In the tree bar 223, a path to the node, in place of the node name as described above, may be displayed.

Thus, by using the node name of or path to the displayed parent node separately from representation indicating its subordinate range, even a node name having a length of the text to be displayed in the tree bar 223 that cannot fully be contained in the parent node displaying parent/child nodes lying region 226 can be prevented from omission, and the node name and its subordinate range can be recognized together.

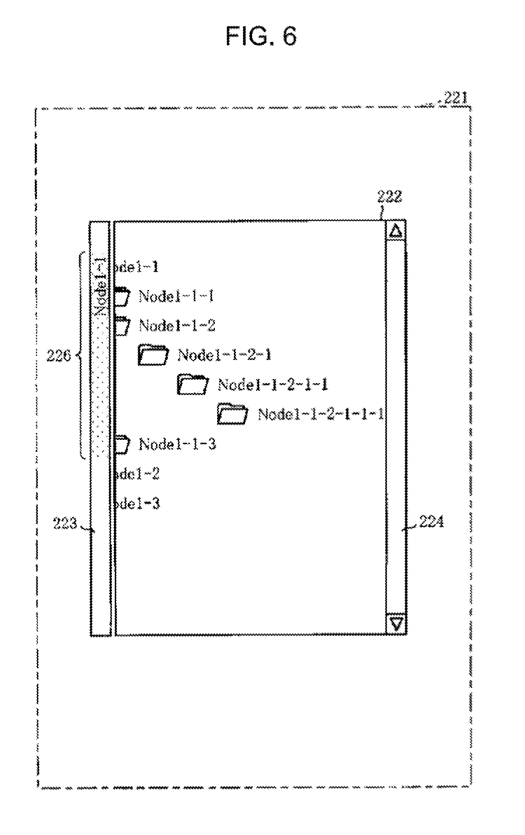

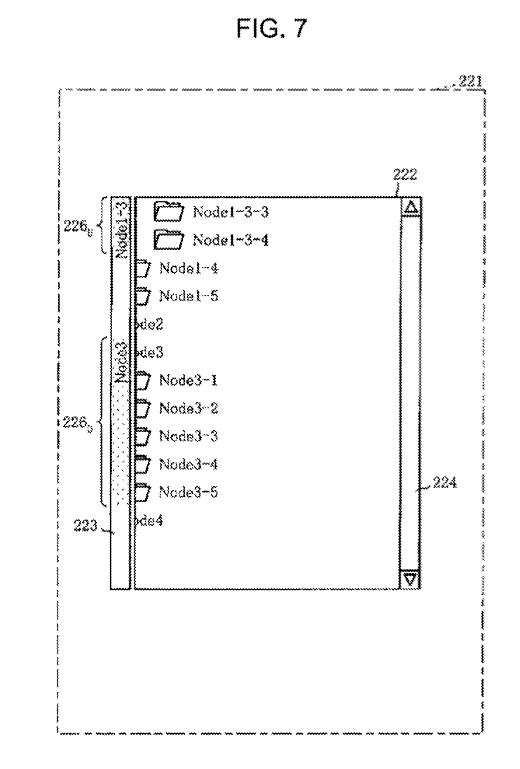

FIGS. 6 and 7 show display in a case that display cannot be fully contained in the tree display area because node levels go deeper. Among these nodes, three nodes, “Node 1-1,” “Node 1-2” and “Node 1-3,” have the heads of their texts extending beyond the left edge of the tree display area 222 to the outside in FIG. 6 and the characters are omitted from display. Therefore, these nodes are manipulated as if they themselves were not displayed, because their texts are not displayed from their respective heads. Thus, the child nodes whose parent node is required to be displayed are “Node 1-1-1,” “Node 1-1-2” and “Node 1-1-3” in this display example of FIG. 6. Consequently, the tree display area 222 displays the text “Node 1-1” as indication of the parent node. This is related to the processing at Steps S302 and S305 in FIG. 3.

On the other hand, referring to FIG. 7, two upper and lower parent node displaying parent/child nodes lying regions 226_{U}, 226_{D} are placed in the tree display area 222. Of these regions, the upper parent node displaying parent/child nodes lying region 226_{U} displays the text for the parent node “Node 1-3” of two nodes “Node 1-3-3,” “Node 1-3-4.”

Next, consider “Node 3” that is a parent of “Node 3-1.” “Node 3” is not contained in the path to “Node 1-3” (\\root\Node 1\Node 1-3) that is already determined as a parent node by the processing of FIG. 3 (Step S306: Y). Therefore, the text for “Node 3” is displayed in the lower parent node displaying parent/child nodes lying region 226_{D} in the tree bar 223. Thus, it is possible for a user to recognize the node name and its subordinate range together even for a tree structure having too deep levels to be fully contained in the width of the tree region.

As described above, according to the first embodiment of the present invention or its example, the tree bar 223 is provided in the proximity of the tree display area 222, a node for which information about a parent node (or a path thereto) should be displayed is selected with reference to the current display of the tree display area 222, and the parent node information whose background color or text arrangement position is determined corresponding to the display of the tree display area 222 is displayed in the tree bar 223. Thus, a user is allowed to recognize a parent node (or its path) of a node currently displayed and a range encompassed by the parent node without moving his/her eyes over a long distance from the tree display area 222 or without performing any operation such as selecting a specific node.

### Second Embodiment

Next, a second embodiment of the present invention will be described.

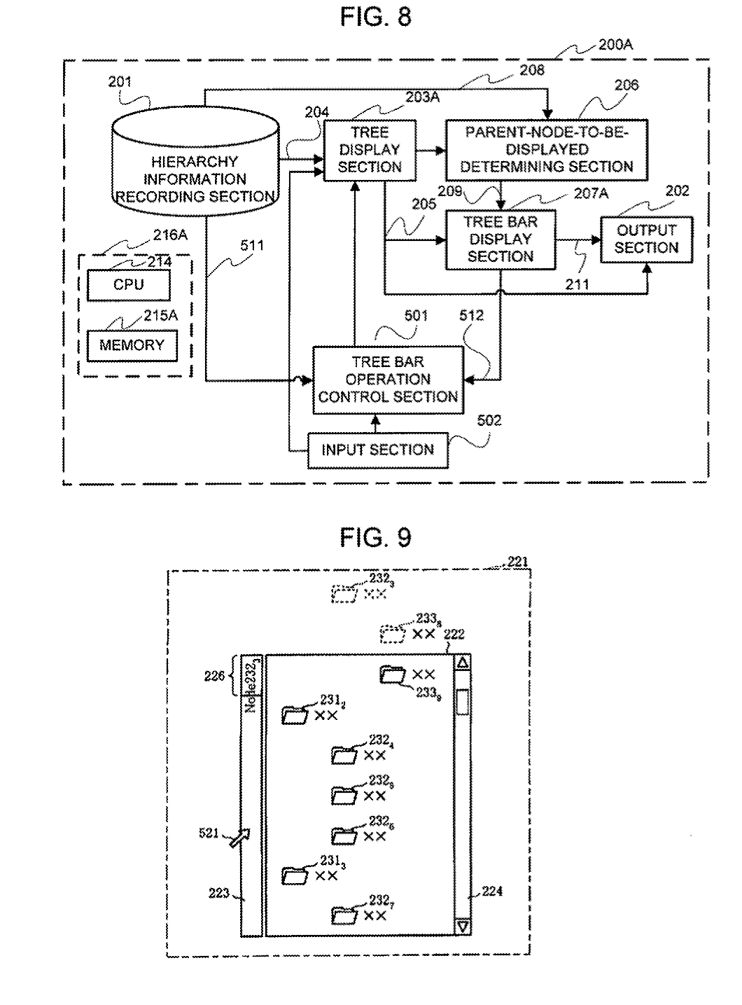

FIG. 8 represents a configuration of a hierarchical structure display apparatus in the second embodiment. Parts in FIG. 8 similar to those in FIG. 1 are designated by similar reference symbols, and explanation thereof will be omitted as appropriate. In a hierarchical structure display apparatus 200A in the second embodiment, a tree bar operation control section 501 for controlling the operation of the tree bar is provided in the hierarchical structure display apparatus 200 of the first embodiment shown in FIG. 1. By an input operation via an input section 502, the tree display section 203A and tree bar operation control section 501 can be operated. For the input section 502, a mouse, for example, serving as a pointing device is employed. The memory 215A in the control section 216A stores therein control programs corresponding to the control functions of the hierarchical structure display apparatus 200A in the second embodiment.

In the thus-configured hierarchical structure display apparatus 200A, the tree bar operation control section 501 looks up hierarchical data 511 output from the hierarchy information recording section 201 and a current command status 512 in the tree bar output by the tree bar display section 207A. Then, in response to the command status 512, the position for displaying the tree structure in the tree display area 222 shown in FIG. 2 is shifted depending upon the specification of the command.

FIG. 9 shows an example of display at the output section. An overview of system control for displaying a tree structure will be described with reference to FIGS. 9 and 2. As compared with the display shown in FIG. 2, the node 233₈ displayed at the upper end in the tree display area 222 in FIG. 2 lies outside the tree display area 222 and is not displayed in the actual display screen 221 in FIG. 9. The tree bar 223 shows a text “Node 232₃” indicating the node 232₃ that is a parent node of the child node 233₉.

In the display shown in FIG. 9, the child node 233₉ is shown in the tree display area 222 and it can be seen that its parent node is the node 232₃, but it cannot be known how many child nodes exist subordinate to the parent node 232₃. To know this, the user may operate the slider bar 224 to shift the display of the tree structure in the tree display area 222 in a vertical direction. However, in a case that the tree displayed in the tree display area 222 has a larger size, a careful operation of the slider bar 224 is required; otherwise, the display of the tree structure would be shifted too much in the tree display area 222 to attain the intention.

According to the second embodiment of the present invention, in response to such a requirement, the user operates the input section 502 shown in FIG. 8 to cause a cursor 521 to point at the tree bar 223. Then, the tree bar 223 may be clicked on by the tip of the cursor 521. The hierarchical structure display apparatus 200A then shifts the display in the vertical direction of the region such that all child nodes 233₈, 233₉ subordinate to the parent node 232₃ are sequentially displayed in the tree display area 222 from its upper end as shown in FIG. 2. Thus, the user can readily recognize the presence of the two child nodes 233₈, 233₉ subordinate to the parent node 232₃, and immediately start processing to these nodes, for example.

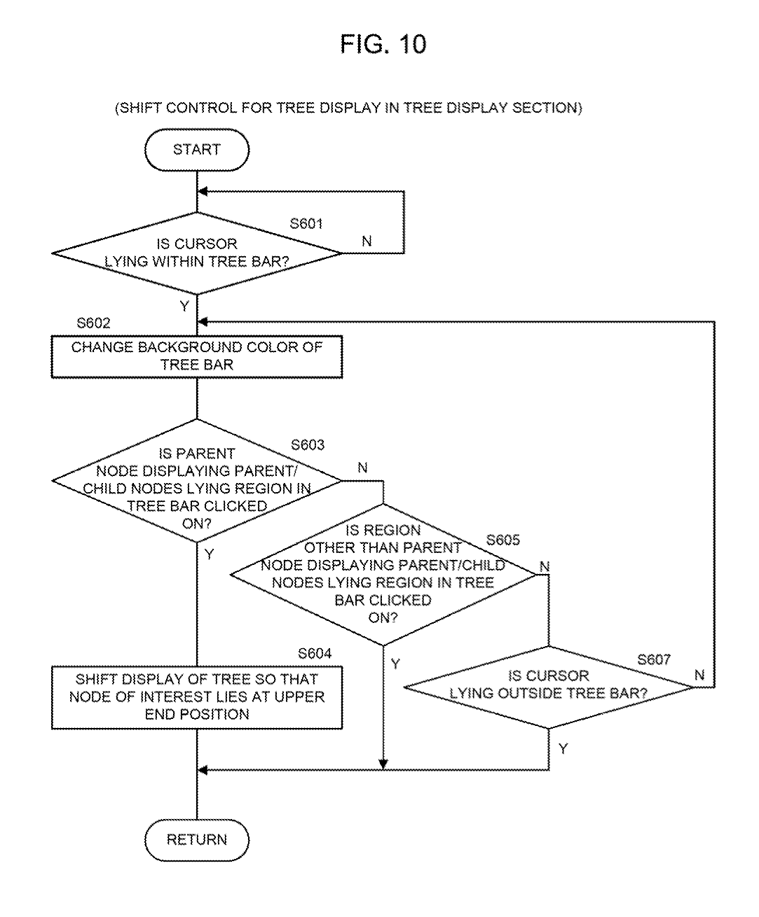

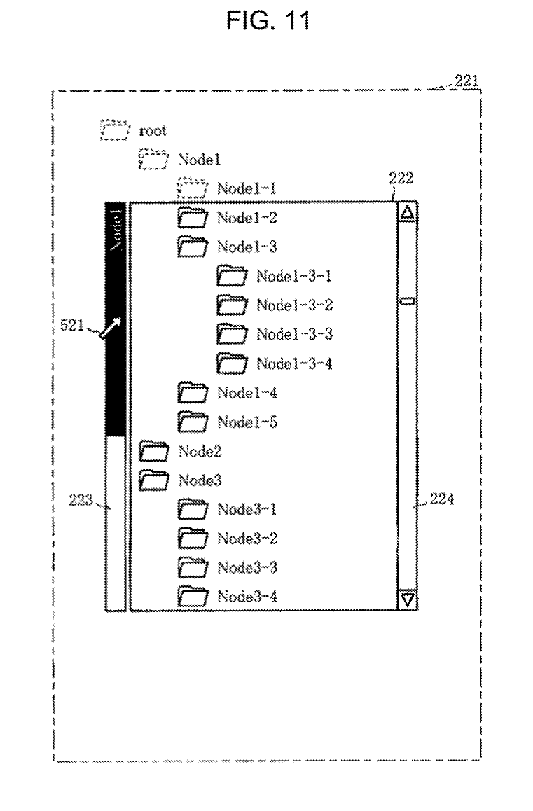

FIG. 10 is a chart representing an example of shift control for tree display in the tree display section. The following description will be made with reference to FIGS. 8 and 9. The tree bar operation control section 501 checks an output of the tree bar display section 207A to thereby monitor whether the tip of the cursor 521 goes over the tree bar 223 (mouse-over) (Step S601). In a case that the tip of the cursor 521 goes over the tree bar 223 (Y), the background color of the tree bar 223 is changed from light blue to yellow, for example (Step S602), to let the user know that shift control for tree display is now in a wait status.

When the user uses the tip of the cursor 521 to click on the parent node displaying parent/child nodes lying region 226 under this display condition (Step S603: Y), the tree bar operation control section 501 detects the operation, and shifts the display of the tree so that the first child node 233₈ subordinate to the parent node 232₃ of interest lies at an upper end position of the tree display area 222 (Step S604). Thus, the display of FIG. 2 is now achieved.

On the other hand, when the user uses the tip of the cursor 521 to click on a region other than the parent node displaying parent/child nodes lying region 226 in the tree bar 223 (Step S605: Y), no specific result occurs (Return). When the user moves the tip of the cursor 521 to a region other than the tree bar 223 (Step S607: Y), the background color that was changed at Step S602 returns to its original background color, and shift control for tree display is terminated (End).

### Example 2

Next, as a second example of the present invention, a specific example of display of the tree display area 222 generated by the tree bar display section 207A in FIG. 8 and output by the output section 202 and its vicinity will be shown in some viewports. Reference symbols used in FIGS. 8 and 9 are also used in the second example as appropriate.

FIG. 11 shows a condition in which the tip of a cursor points at the tree bar at Step S602 in FIG. 10. The tree bar 223 is initially colored in light blue, for example, and when the tip of the cursor 521 goes over the tree bar 233 (mouse-over), it is changed to have a black background, for example, and the portion of the text “Node I” is displayed with reversed density. The display mode may be changed in a different manner from that described above. Such a change of display of the tree bar 223 allows the user to know that the mode in which the display position of the tree structure in the tree display area 222 may be shifted according to specification of a command is enabled. In the drawing, the vicinity of the tree structure is illustrated in dashed lines in the proximity of the tree display area 222 as a reference. These items are not displayed in the actual display screen 221, as in the other examples such as that shown in FIG. 4.

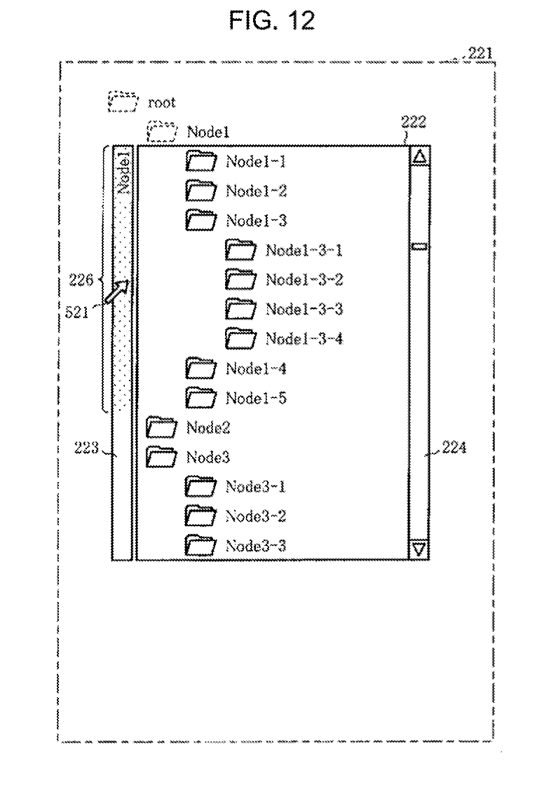

FIG. 12 shows the tree bar shown in FIG. 11 after being clicked on by the mouse. When the parent node displaying parent/child nodes lying region 226 having a color changed in the tree bar 223 is clicked on by the mouse (FIG. 10, Step S603: Y), the display is shifted so that a first one of child nodes “Node 1-1,” “Node 1-2” and “Node 1-3” of a parent node, which is a node represented by the text “Node 1” displayed in the parent node displaying parent/child nodes lying region 226, that is, “Node 1-1,” is displayed in the top of the tree display area 222 (FIG. 10, Step S604). Thus, even in a case that the amount of data to be manipulated is too large to facilitate an elaborate operation by the scroll bar, the user can perform a straightforward operation of quickly and positively displaying a node(s) at a required level in the tree display area 222.

In a case that a design in which a plurality of parent node displaying parent/child nodes lying regions 226_{U}, 226_{D} are placed in the tree bar 223 as shown in FIG. 7 is not assumed, or that one parent node displaying parent/child nodes lying region 226 is displayed in the tree bar 223 as shown in FIG. 11, a region other than the parent node displaying parent/child nodes lying region 226 in the tree bar 223 may be clicked on to achieve shift of the display as shown in FIG. 12.

### Example 3

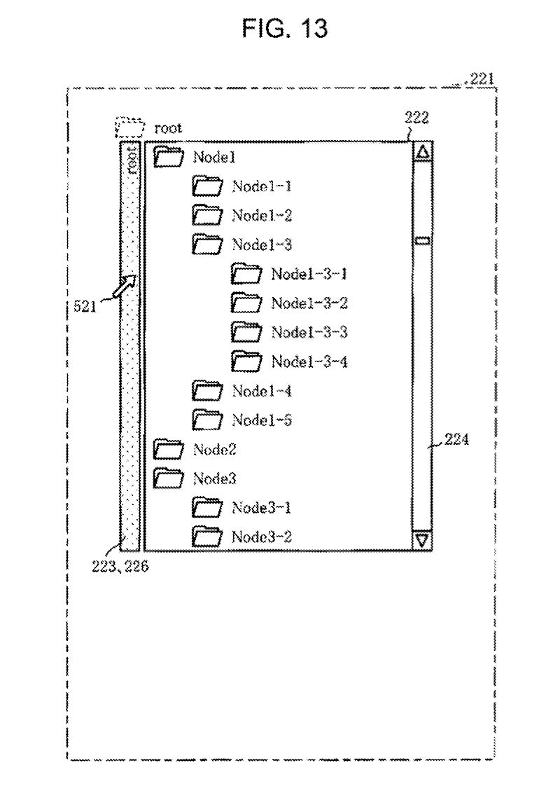

FIG. 13 shows an implementation of the second embodiment as a third example of the present invention. Reference symbols used in FIGS. 8 and 9 are also used in the third example as appropriate.

The third example illustrates a case in which when the parent node displaying parent/child nodes lying region 226 shown in FIG. 11 is clicked on by the cursor 521 pointing at the region 226, the display is shifted so that the node having the text “Node 1” displayed in the region is placed in the top of the tree display area 222. In such display, the text “root” of a parent node having a child node “Node 1” now displayed in the top of the tree display area 222 is displayed in the parent node displaying parent/child nodes lying region 226.

To achieve the display control as in the third example, the control performed at Step S604 in FIG. 10 is modified to that adapted to the third example. Accordingly, a flow chart of the third example is omitted from the description.

### Example 4

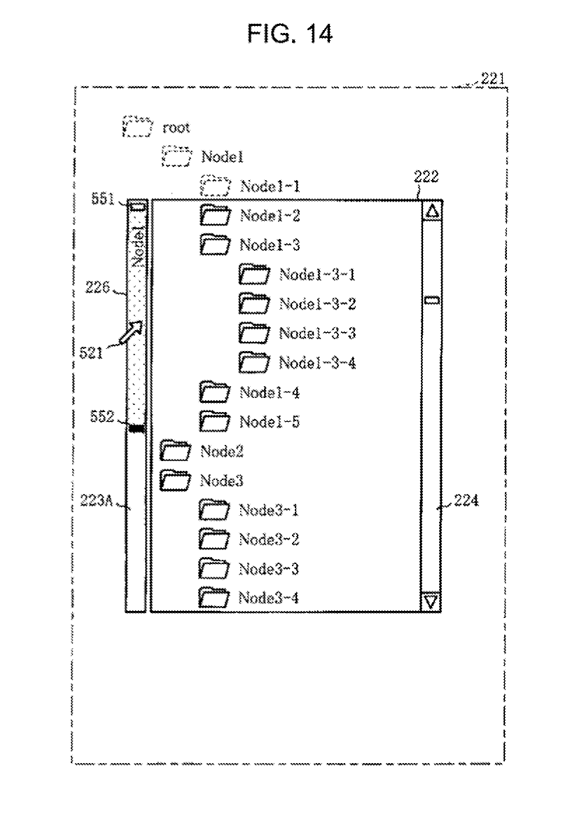

FIG. 14 shows an implementation of the second embodiment as a fourth example of the present invention. Reference symbols used in FIGS. 8 and 9 are also used in the fourth example as appropriate.

The parent node displaying parent/child nodes lying region 226 displayed in a tree bar 223A of the fourth example has a first button 551 placed at an upper end position of the region 226, and a second button 552 is placed at a lower end position, if displayed.

When the user pushes (clicks on) the first button 551 by the tip of the cursor 521, the display is shifted so that “Node 1-1,” which is a topmost one of the child nodes of interest, is placed at the upper end of the tree display area 222. Specifically, the display is modified so that the tree display area 222 is turned to the display as shown in FIG. 12.

On the other hand, when the user pushes the second button 552 by the tip of the cursor 521, the display is shifted so that “Node 1-5,” which is a lowermost one of the child nodes of interest, is placed at the lower end of the tree display area 222. Specifically, the display is shifted downward so that the lower end of the parent node displaying parent/child nodes lying region 226 displayed in the tree bar 223A in FIG. 14 is placed at the lower end of the tree display area 222.

In the fourth example, the first and second buttons 551, 552 also have a function of indicating the display status in the tree display area 222 with respect to the nodes subordinate to the displayed parent node “Node 1.” Specifically, the first button 551 being not lit allows recognition that the first one of the child nodes subordinate to the displayed parent node “Node 1” is not a child node “Node 1-2” currently displayed at the upper end of the tree display area 222, but there still exists an upper node (child node “Node 1-1” in this case) that is subordinate to “Node 1.” When the first button 551 is lit, it would be recognized that a first one of child nodes subordinate to the displayed parent node “Node 1” is displayed at the upper end of the tree display area 222, although this is different from the case illustrated in FIG. 14.

Likewise, the second button 552 being lit indicates that a child node “Node 1-5” that should be placed at the lower end among those subordinate to the displayed parent node “Node 1” is displayed in the tree display area 222. FIG. 14 shows this condition.

It should be noted that a flow chart for implementing the processing of the fourth example may be easily created by modifying FIG. 10. The turn-on/off display of the lights of the first and second button 551, 552 may be made by comparing the display range of the tree display section 203A to a corresponding tree structure recorded in the hierarchy information recording section 201 in FIG. 8. Accordingly, a flow chart for implementing the processing in the fourth example is omitted from the drawings.

### Example 5

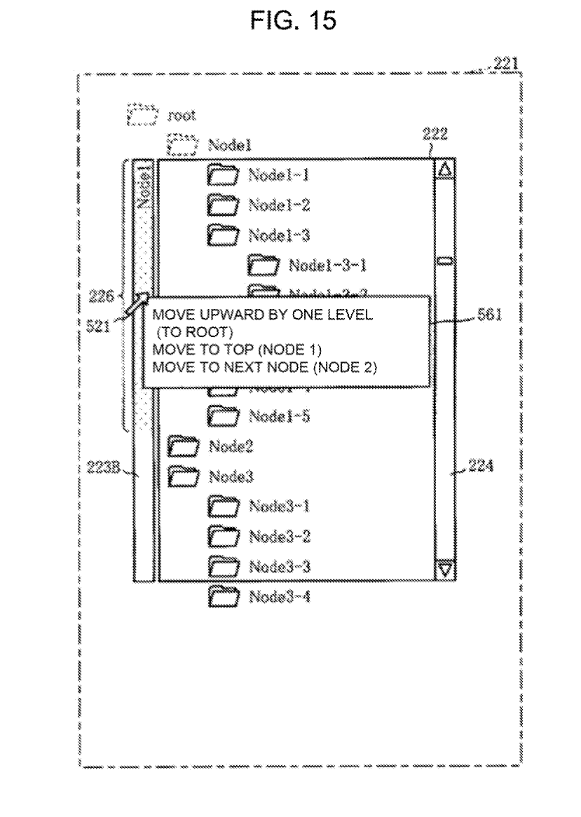

FIG. 15 shows an implementation of the second embodiment as a fifth example of the present invention. Reference symbols used in FIGS. 8 and 9 are also used in the fifth example as appropriate.

In the fifth example, when the user pushes a right button on the mouse (not shown) to click on the tree bar 223B with the tip of the cursor 521 pointing thereat, a pop-up menu 561 is displayed in the display screen 221. In this condition, the user selectively clicks on a desired one of several processing items displayed in the pop-up menu 561, upon which corresponding processing is executed.

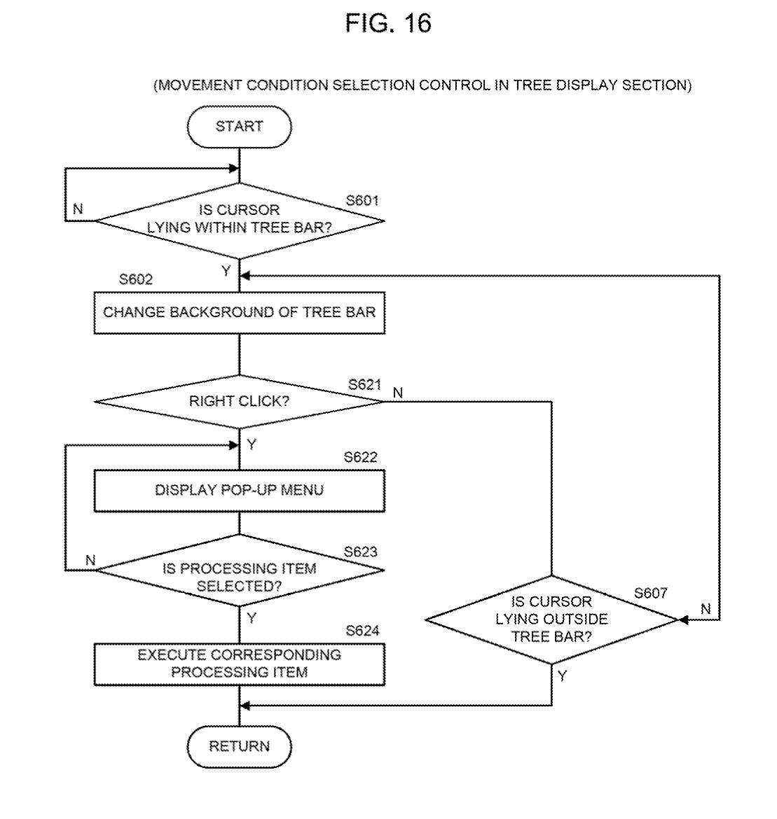

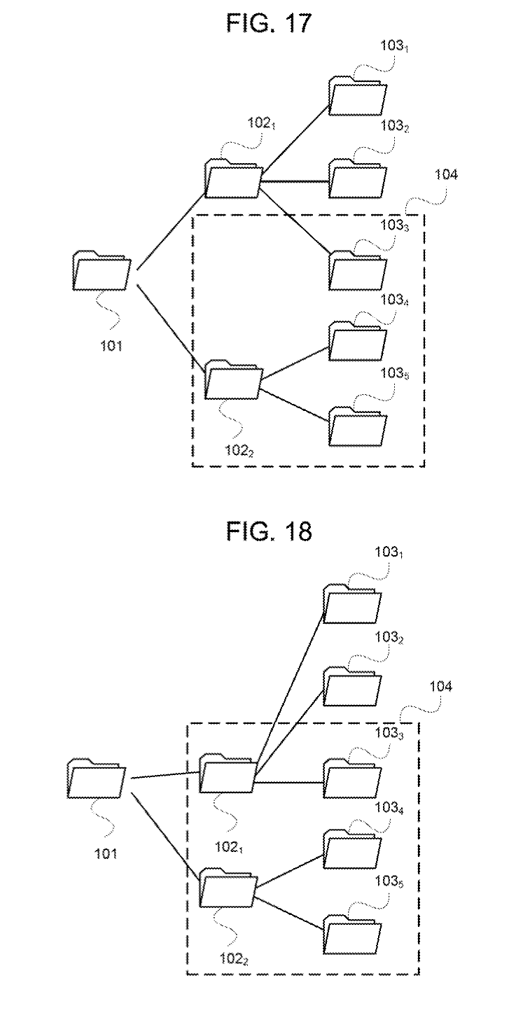

FIG. 16 shows movement condition selection control in the tree display section in the fifth example. Similar portions in FIG. 16 to those in FIG. 10 are designated by similar reference symbols, and description thereof will be omitted as appropriate. The description will be made with reference to FIGS. 8 and 15.

When the tip of the cursor 521 goes over the tree bar 223B (Step S601: Y), causing the background color of the tree bar 223 to be turned from light blue to yellow, for example (Step S602), and the user pushes the right button on the mouse serving as the input section 502 (Step S621: Y), a pop-up menu 561 is displayed in the display screen 221 (Step S622). In this condition, when the user uses the mouse to select one of processing items in the menu (Step S623: Y), the processing item is executed (Step S624). For example, when a topmost one of three processing items shown in FIG. 15 is selected, a control section (not shown) corresponding to the control section 216A causes a node “root” immediately above the parent node “Node 1” displayed in the parent node displaying parent/child nodes lying region 226 to be displayed in the parent node displaying parent/child nodes lying region 226, and also causes “Node 1” and its subordinate nodes to be displayed from the top position in the tree display area 222. In a case that another processing item is selected from the pop-up menu 561, the selected processing item will be executed.

Rather than pushing the right button of the mouse at Step S621 (N), the user may move the tip of the cursor 521 to a region other than the tree bar 223 (Step S607: Y); in such a case, the background color that has changed at Step S602 returns to its original background color, and shift control for the tree display is terminated (End).

As described above, the second embodiment, its examples, and examples of modifications of the second embodiment may be used to specify a destination of the moved tree region by, for example, selecting parent node information displayed on the tree bar 223, 223A, 223B to display the parent node from its head in the display of the tree display area 222. Thus, as compared with a case in which data of a large tree structure is manipulated by the scroll bar 561, an operation of fine adjustment of the display position may be quickly and positively achieved. Specifically, in handling a large hierarchical structure, a thumb button of the scroll bar is difficult to select as its size becomes smaller, and in addition, a small movement of the thumb button results in a large movement of the displayed data; these problems are eliminated according to these embodiments or examples.

Moreover, the second embodiment and its related examples may be employed to identify a parent node (or its path) of a node currently displayed in the tree display area 222 and a range the parent node encompasses, without the user moving his/her eyes from the displayed portion in the tree or performing an operation such as selecting a specific node. Furthermore, buttons or icons having limited functions may be placed in the tree bar 223 to allow the user to selectively operate a desired one of them, so that an operation of fine adjustment of the displayed position may be quickly and positively achieved.

While in the examples described above, the buttons are placed in the tree bar 223A, several kinds of icons may be placed. Moreover, it is possible to employ another operation method, such as that involving dividing the region of the tree bar 223, 223A, 223B to assign a plurality of functions thereto, or a known technique for specification of a position to be displayed in the tree display area 222.

Moreover, while the embodiments and examples above display each pair of icons of folders without linking them by a link line therebetween, the present invention may be applied to a display mode in which they are linked by a link line.

The present application claims priority based on Japanese Patent Application No. 2007-315761 filed on Dec. 6, 2007, disclosure of which is incorporated herein in its entirety.

1-10. (canceled)

11. A hierarchical structure display apparatus comprising:
a hierarchical data storage for holding hierarchical data which is data in a hierarchical structure;
a tree region generator for receiving said hierarchical data from said hierarchical data storage as an input, and generating a tree region in which nodes are displayed in a tree form within a predetermined viewport in a predetermined direction from one end of said viewport in a sequence of a hierarchical relationship from a node at an upper level toward its subordinate node at a lower level;
a presence-of-parent-node deciding unit for deciding whether a node contained in the tree region generated by said tree region generator has a node at an immediately upper level corresponding to a parent falling outside the tree region, from a relationship between the hierarchical data supplied to said tree region generator from said data storage for display and its vicinal hierarchical data; and
a parent-node-identifying-information display for, when it is decided by said presence-of-parent-node deciding unit that said node at the level corresponding to a parent falling outside said tree region exists, displaying parent node identifying information representing said node at a predetermined position.

12. A hierarchical structure display apparatus according to claim 11, wherein said presence-of-parent-node deciding unit comprises a parent node determining unit for, for a node whose parent node, which is a node at a level immediately above said node, is not displayed within said predetermined viewport, confirming whether each parent node is contained in a path to a node already determined as a parent node sequentially from said end of said viewport, and in a case that it is not included, determining a parent node of said node as a parent node to be displayed.

13. A hierarchical structure display apparatus according to claim 11, wherein said parent-node-identifying-information display is placed in the proximity of said viewport for displaying the tree region generated by said tree region generator.

14. A hierarchical structure display apparatus according to claim 13, wherein the proximity of said viewport refers to a billet-shaped tree bar adjacent to said viewport.

15. A hierarchical structure display apparatus according to claim 14, wherein said tree bar has such a length as to cover a whole range of said viewport in said predetermined direction, said parent node identifying information is displayed within said tree bar as text information about the parent node, and a region in which child nodes subordinate to said displayed parent node lie is displayed in a manner visually discriminable from other regions within the tree bar.

16. A hierarchical structure display apparatus according to claim 15, wherein said text information about the parent node has its display position defined around the region in which said subordinate child nodes lie.

17. A hierarchical structure display apparatus according to claim 15, wherein said manner visually discriminable refers to a condition in which a background color is different between said region in which the child nodes subordinate to the parent node lie and other regions.

18. A hierarchical structure display apparatus according to claim 14, comprising a region shift commanding unit for shifting a region in which said tree region is generated so that one of said child nodes subordinate to the parent node displayed within said tree bar that is to be placed in the top of the tree structure is placed on the side of said end of said viewport.

19. A hierarchical structure display method comprising:
a tree region generating step of receiving, from a hierarchical data storage for holding hierarchical data which is data in a hierarchical structure, said hierarchical data as an input, and generating a tree region in which nodes are displayed in a tree form within a predetermined viewport in a predetermined direction from one end of said viewport in a sequence of a hierarchical relationship from a node at an upper level toward its subordinate node at a lower level;
a presence-of-parent-node deciding step of deciding whether a node contained in the tree region generated at said tree region generating step has a node at an immediately upper level corresponding to a parent falling outside the tree region, from a relationship between the hierarchical data supplied and displayed at said tree region generating step and its vicinal hierarchical data; and
a parent-node-identifying-information display step of, when it is decided at said presence-of-parent-node deciding step that said node at the level corresponding to a parent falling outside said tree region exists, displaying parent node identifying information representing said node at a predetermined position.

20. A hierarchical structure display control program causing a computer that comprises a hierarchical data storage for holding hierarchical data which is data in a hierarchical structure, to execute:
tree region generating processing of receiving said hierarchical data from said hierarchical data storage as an input, and generating a tree region in which nodes are displayed in a tree form within a predetermined viewport in a predetermined direction from one end of said viewport in a sequence of a hierarchical relationship from a node at an upper level toward its subordinate node at a lower level;
presence-of-parent-node deciding processing of deciding whether a node contained in the tree region generated by said tree region generating processing has a node at an immediately upper level corresponding to a parent falling outside the tree region, from a relationship between the hierarchical data supplied for said tree region generating processing from said data storage and its vicinal hierarchical data; and
parent-node-identifying-information display processing of, when it is decided by said presence-of-parent-node deciding processing that said node at the level corresponding to a parent falling outside said tree region exists, displaying parent node identifying information representing said node at a predetermined position.

21. A hierarchical structure display method according to claim 19, wherein said presence-of-parent-node deciding step comprises, for a node whose parent node, which is a node at a level immediately above said node, is not displayed within said predetermined viewport, confirming whether each parent node is contained in a path to a node already determined as a parent node, sequentially from said end of said viewport, and in a case that it is not included, determining a parent node of said node as a parent node to be displayed.

22. A hierarchical structure display method according to claim 19, wherein said parent-node-identifying-information display step comprises displaying in the proximity of said viewport for displaying the tree region generated at said tree region generating step.

23. A hierarchical structure display control program according to claim 20, wherein said presence-of-parent-node deciding processing comprises, for a node whose parent node, which is a node at a level immediately above said node, is not displayed within said predetermined viewport, confirming whether each parent node is contained in a path to a node already determined as a parent node sequentially from said end of said viewport, and in a case that it is not included, determining a parent node of said node as a parent node to be displayed.

24. A hierarchical structure display control program according to claim 20, wherein said parent-node-identifying-information display processing comprises displaying in the proximity of said viewport for displaying the tree region generated by said tree region generating step.
